(19) United States
(12) Patent Application Publication
(10) Pub. No.: US 2014/0278566 A1
(43) Pub. Date: Sep. 18, 2014

(54) SYSTEM AND METHOD FOR WORKERS' COMPENSATION RELATIONED RISK ANALYSIS

(71) Applicant: HARTFORD FIRE INSURANCE COMPANY, Hartford, CT (US)

(72) Inventors: Kelly J. McLaughlin, Hartford, CT (US); Carmen L. Sharp, Hartford, CT (US); Steven M. Byam, Hartford, CT (US); Sheila Marie Fanous Migliozzi, Hartford, CT (US); William B. Sullivan, Hartford, CT (US)

(73) Assignee: HARTFORD FIRE INSURANCE COMPANY, Hartford, CT (US)

(21) Appl. No.: 13/839,098

(22) Filed: Mar. 15, 2013

(51) Int. Cl. G06Q 40/08

(52) U.S. Cl. CPC G06Q 40/08
USPC 705/4

(57) ABSTRACT

A system and method for workers' compensated risk analysis. The method comprising transmitting standard workers' compensation questions to a user device, receiving a response to the set of standard workers' compensation, selecting a set of supplemental questions based on the received responses to the set of standard workers' compensation questions and transmitted the set of supplemental questions to the user device, receiving a response to the set of supplemental questions and generating a risk score for workers' compensation insurance based on at least the responses to the standard questions and the supplemental questions.

### TECHNICAL FIELD

The subject matter disclosed herein relates to computer systems and data communication systems. More particularly, the subject matter disclosed herein related to the electronic storage, communication, processing, and display of data related to business insurance and other insurance products.

### BACKGROUND

Workers' compensation is typically a no-fault insurance program governed by state laws. In addition to state workers compensation programs, there are various federal programs that govern employment of specific classes of employees. Federal employee protection programs include the United States Longshore and Harborworkers' Compensation Act (USL&H), the Federal Employers Liability Act (FELA), the Jones Act, and the Defense Base Act. Employers covered by state and federal employee protection legislation may provide payments for medical costs and lost wages when employees are injured at work. In exchange for providing wage replacement and indemnity benefits for injured workers, employers often enjoy protection from liability claims. Workers' compensation insurance is required by law in most states. However, each state's rules may vary.

Workers' compensation statutes may require employers to pay for covered medical benefits, such as, doctor visits, hospital procedures, prescription drugs, and rehabilitation. In addition to medical benefits, compensation statutes may require employers to provide wage loss benefits when injured employees are unable to work.

The general basis of workers compensation premium calculation is determined by using an appropriate rate for each class of workers at a business and multiplying that rate times the employer's payroll in each class. Workers'compensation insurance applications tend to provide all the basic information that will assist insurance carriers in rating and pricing new businesses. Applications may focus inquiry on the elements of a risk that are required by law to rate a business. Additionally, applications may help to classify the workers by asking questions regarding the work operations and additional coverages that may be needed. For example, if an employer has workers that engage in operations subject to the Jones Act, or the Defense Base Act, additional types of coverage may be included in the policy to offer coverage for those exposures.

However, current methods may not accurately assess the risk for the insurer, and therefore may not allow the insurer to adequately assess premiums for coverage. Once a business has been classified correctly, and payrolls have been accurately captured, insurers must still decide upon what type of pricing flexibility is appropriate. In addition to pricing flexibility, some elements of a risk may prove to be unacceptable to an insurer because it does not fit the insurer's available pricing levels, or appetite. Accordingly, methods and apparatus are presented herein that solicit additional information allowing for improved workers' compensation risk analysis.

### SUMMARY

A system for workers' compensated risk analysis. A system for the generating automated underwriting information related to workers' compensation insurance for a business, may include a memory device configured to store a set of standard workers' compensation questions and a set of supplemental questions, a transmitter configured to transmit the set of standard workers' compensation questions to a user device, a receiver configured to receive a response to the set of standard workers' compensation questions from the user device and to store the response to the set of standard workers' compensation questions in the memory device. The processor may be configured to select a subset of the set of supplemental questions based on the received responses to the set of standard workers' compensation questions. The transmitter may be further configured to transmit the subset of supplemental questions to the user device. The receiver may be further configured to receive a response to the subset of supplemental questions and to store these responses in the memory device. The processor may be further configured to generate a risk score for workers' compensation insurance based on at least the responses to the standard workers' compensation questions and the responses to the supplemental questions. The processor may be further configured to determine an insurance company with an appetite to insure the business based on the determined risk score. The transmitter may be further configured to transmit the information concerning the determined insurance company to the user device.

### BRIEF DESCRIPTION OF THE DRAWINGS

A more detailed understanding may be had from the following description, given by way of example in conjunction with the accompanying drawings wherein:

FIG. 1 shows an example architecture for communicating, displaying, and processing data related to insurance products;

FIG. 2A shows a flow diagram of a system for workers' compensation risk analysis;

FIG. 2B shows a flow diagram of a method for supplemental pricing adjustment;

FIG. 3 shows an example web page that includes questions that solicit information from a business owner related to an application for workers' compensation coverage;

FIG. 4 shows a second example web page that includes supplemental questions for soliciting information from a business owner related to the business;

FIG. 5 shows a third example web page that includes questions for soliciting information from a user regarding sources for census data related to the business;

FIG. 6 shows an fourth example web page that includes questions for soliciting information related to individual employee's census information;

FIG. 7 shows an example results page that includes pricing and premium information based on the user's answers to the questions solicited in FIGS. 3-6;

FIG. 8 shows an example computing device that may be used to implement features described herein with reference to FIGS. 1-7; and

FIG. 9 shows an example cellular phone that may be used to implemented features described herein with reference to FIGS. 1-8.

### DETAILED DESCRIPTION

As described hereinbefore, workers' compensation insurance is typically a no-fault insurance program governed by state laws. The base premium for workers' compensation insurance may typically be calculated as follows:

(Payroll/100)*Rate

Different companies may offer different rates. However, the rate for a particular company may be fixed by law. The rate offered by an insurer may be related to the amount of risk associated with the business to be insured. Insurers with a low risk appetite may offer a lower rate and refuse to offer coverage to a business with a higher risk.

Methods and apparatus are described in greater detail hereafter that solicit supplemental information to allow a more accurate determination of the risk factors involved and therefore match the appropriate insurer with a particular business. In general, the business is presented with a list of primary questions (generally governed by state law). Based on the responses to those questions, the system determines supplemental questions to clarify and categorize the responses to the previous questions. The system may also receive census data and/or additional data originating from outside the business. Based on the answers to the primary questions, the supplementary questions and any census data, the system more accurately determines the risk associated with coverage for the business. The system then performs a search and identifies a company that may accept the risk at the determined rate.

FIG. 1 shows an example architecture 100 for communicating, displaying, and processing data related to workers' compensation related insurance products. The example architecture 100 includes a web site system 120, and multiple user devices (including client device 110, an agent device 111), a policy management system 104, and one or more communication networks 102. The web site system 120 may provide access to a web site that is managed by an insurance company. The client device 110 may access the web site via the one or more communication networks 102, and display the web site to a user of the client device 110. The user may be, for example, a business owner. Alternatively, the client device may access the agent device 111, which is operably connected to the web site system 120. The user may also be an agent, speaking to a business owner. In this scenario, the information is entered directly from the agent device 111 to the web site system 120; the web site may include a page that includes questions of one or more types.

As an example, questions of a first type may solicit information regarding standard application information related to workers' compensation, these questions may be determined based on state law. Questions of a second type may solicit supplemental information related that may provide improved risk analysis information to the insurance company. The questions of the second type may be determined based on the responses to the questions of the first type to further clarify and categorize the first response.

The user may provide information that is responsive to the questions, which may then be transmitted to the web site system 120 by the client device 110. The web site system 120 may further collect census information, either from the user, from information associated with a different insurance product, or some outside source. The web site system 120 may then determine, based on the information provided by the user in response to the questions and any other collected data, a risk associated with providing coverage. Based on this risk, the web site system 120 may determine an insurance company or a particular insurance coverage with a predetermined rate that has an appetite for the determine level of risk. The web site system 120 may then transmit additional information back to a user (e.g. client device 110 or agent device 111), related to the companies prepared to accept the risk and the associated premium and pricing information. A user, using the client device 110 or agent device 111 may then initiate the purchase of an insurance product (by, for example, contacting an agent or employee of the insurance company, or processing the transaction directly from the website)), and/or enter into a binding agreement for the purchase of the product.

Additionally, or alternatively the web site system 120 may be able to access data concerning the employer from external websites. For example, the web site system 120 may be able to access employer data about the employer from the OSHA website. This data may be used directly in rate determination. Additionally, this data may be used to verify data entered by the user. Data obtained from external sources may also be used to update the skip logic of the web site system 120, allowing the web site system 120 to present the user with fewer questions.

The web site system 120 may include a HyperText Transfer Protocol (HTTP) server module 123, a Content Management System (CMS) 126, a product quoting/binding module 122, a web site database 128, a results module 124, and a risk analysis module 125. The HTTP server module 123 may implement the HTTP protocol, and may communicate HyperText Markup Language (HTML) pages and related data from the web site to/from the client device 110 using HTTP. The HTTP server module 123 may be, for example, an Apache HTTP server, a Sun-ONE Web Server, a Microsoft Internet Information Services (IIS) server, and/or may be based on any other appropriate HTTP server technology.

The web site database 128 may store information that describes and provides the content of the web site. The web site database 128 may be a relational database, a hierarchical database, an object-oriented database, one or more flat files, one or more spreadsheets, and/or one or more structured files. The web site database 128 may be managed by a database management system (not depicted) in the web site system 120, which may be based on a technology such as Microsoft SQL Server, MySQL, PostgreSQL, Oracle Relational Database Management System (RDBMS), a NoSQL database technology, and/or any other appropriate technology. In addition to the page that includes one or more questions that solicit information regarding the user's business, the web site may include one or more Electronic Books (E-Books) that provide information related to the business insurance products offered by the insurance company. Information describing the web pages and the E-Books that constitute the web site may be stored in the web site database 128.

The CMS 126 may be used by administrators of the web site to manage the content of the web site stored in the web site database 128. The CMS 126 may change the content of the web site by adding, deleting, or modifying data in the web site database 128 via the database management system. The CMS 126 may be, for example, a Fatwire system, a Drupal system, a Joomla system, an IBM Lotus Web Content Management system, and/or may be based on any other appropriate CMS technology.

The quoting/binding module 122 may be, or may include, one or more web applications that, in conjunction with the HTTP server module 123, the CMS 126, and/or the policy management system 104, may be used to provide one or more web pages to the client device 110 that provide risk analysis estimates and a price quote for an insurance product offered by the insurance company. Alternatively or additionally, the one or more web applications, in conjunction with the HTTP server module 123, the CMS 126, the risk analysis module 125, and/or the policy management system 104, may be used to enter the user of the client device 110 into a binding agreement for the purchase of an insurance product via the web site.

As described above, the web site system 120 may transmit web pages to the client device 110 that may include one or more questions that solicit information regarding the an application for workers' compensation insurance. This may be performed by, for example, the HTTP server module 123 in conjunction with the CMS 126 and/or the web site database 128. Also as described above, the user may provide information that is responsive to the questions, which may then be transmitted to the web site system 120 by the client device 110. The information may be received via the HTTP server module 123, which may then provide the information to the results module 124 and/or the risk analysis module 125.

Based on the information responsive to the first type of questions and the second type of questions, the risk analysis module 125 may determine risk/exposure related to the insurance coverage and determine a risk level associated with the business. The risk analysis module 125 may send this information to the results module 124. The results module 124 may be configured to determine an insurance company with an appetite for the determined risk and the associated rate for that insurance company. The results module 124, in conjunction with the HTTP server module 123 and/or the CMS 126, may then transmit information back to the client device 110 related to the rate and insurance company information that has been determined by the results module 124 and the risk analysis module 125 as applicable to the user's business.

The web site system 120 may also include one or more additional components or modules (not depicted), such as one or more load balancers, firewall devices, routers, switches, and devices that handle power backup and data redundancy.

The client device 110 may include a web browser module 112, which may communicate data related to the web site to/from the HTTP server module 123 in the web site system 120 via the one or more communication networks 102. The web browser module 112 may include and/or communicate with one or more sub-modules that perform functionality such as rendering HTML (including but not limited to HTML5), rendering raster and/or vector graphics, executing JavaScript, and/or rendering multimedia content. Alternatively or additionally, the web browser module 112 may implement Rich Internet Application (RIA) and/or multimedia technologies such as Adobe Flash, Microsoft Silverlight, and/or other technologies. The web browser module 112 may implement RIA and/or multimedia technologies using one or web browser plug-in modules (such as, for example, an Adobe Flash or Microsoft Silverlight plugin), and/or using one or more sub-modules within the web browser module 112 itself.

The web browser module 112 may display data on one or more display devices (not depicted) that are included in or connected to the client device 110, such as a liquid crystal display (LCD) display or monitor. The client device 110 may receive input from the user of the client device 110 from input devices (not depicted) that are included in or connected to the client device 110, such as a keyboard, a mouse, or a touch screen, and provide data that indicates the input to the web browser module 112. The client device 110 may be, for example, a cellular phone, a laptop computer, a tablet computer, or any other appropriate computing device.

The policy management system 104 may perform functionality such as managing information related to one or more insurance products held by the insurance company or by companies affiliated with the insurance company. The policy management system 104 may include a product management database 106, which may store information that describe clients of the insurance company and the policies products provided to the clients by the insurance company. The web site system 120 may also include the product management database 106. The product management database 106 may be a relational database, a hierarchical database, an object-oriented database, one or more flat files, one or more spreadsheets, and/or one or more structured files. The product management database 106 may be managed by a database management system (not depicted). When a client enters into an agreement for the purchase of a product with the insurance company, information related to the agreement may be added to the product management database 106. Alternatively or additionally, when a user of the client device 110 enters into an agreement for the purchase of a product via the quoting/binding module 122 in the web site system 120, the quoting/binding module 122 may communicate with the policy management system 104, and the product management database 106 may be updated accordingly.

The one or more communication networks 102 in the example architecture 100 may include one or more private Local Area Networks (LANs), and/or one or more public communication networks such as the Internet. The one or more communication networks 102 may be based on wired and/or wireless networking technologies.

The architecture 100 of FIG. 1 may be implemented using any number of different network topologies and computing devices. For example, each of the quoting/binding module 122, HTTP server module 123, CMS 126, and results module 124 may be implemented using a single computing device, as one or more separate computing devices, or spread across any two or more computing devices, in any combination. Further, the policy management system 104 may be implemented using a single computing device, as one or more separate computing devices, or spread across any two or more computing devices. An example of a computing device that may be used for the implementation of any or any combination of these entities 122, 123, 124, 125, 126, 128 and 104 is the computing device 800 that is described below with reference to FIG. 8. Alternatively or additionally, the client device 110 may be implemented using a computing device such as the computing device 800 that is described below with reference to FIG. 800 or the cellular phone 900 described below with reference to 9.

FIG. 2A shows a flow diagram of a method 200 for workers' compensation risk analysis. The method 200 may begin with storing application questions for workers' compensation coverage and generating an application for workers' compensation insurance 201. This may include the system receiving inputs from a user including question data which is merged with a template to present to a user. Because this is a regulated industry the first set of questions presented may be determined by the governing state and federal laws, the system may automatically, or otherwise, receive updates from government agencies concerning questions that may be asked. This information may be stored in a database and converted into a format to present the user, e.g. a PDF, a webpage, or some other electronic format viewable on a user device.

The user may access the application by operating a user device capable of communicating with the web site system 120. The web site system 120 transmits the application questions relating to workers' compensation coverage to the user device, which is presented to the user via the web browser module 112 in step 202. The user may be an agent, accessing the web site 120 via an agent device 111. Alternatively, the user may be a potential client directly accessing the web site 120 via a client device 110. Alternatively, the user may use a client device 110 to access an agent device 111 which is operably connected to the web site system 120.

The user inputs data, via the web browser module 112, that is responsive to questions related to the application for workers' compensation coverage. The input data from the responses are received by the web site system 120 and stored at step 203. In general, based on the received answers, the web site system 120 may establish a baseline risk that an insurer would take on, However, as described in the steps hereafter, the web site system 120 may solicit additional information from the user and/or external systems allowing the web site system 120 to credit or debit the risk level to more accurately assess the risk.

Based on the received input data, the web site system 120 then determines supplemental questions that may be useful in the calculation of risk in step 204. These questions may seek further information regarding the received data that allows the system to better categorize, classify, and/or quantify the risk. For example, if the user indicates in step 203 that the business has drug testing, the supplemental questions may solicit additional details concerning the type and frequency of the tests.

In one embodiment, a subset of supplemental questions may be stored in the database. The web site system 120 implements a software-based algorithm to select questions from the subset of supplemental questions. These questions may be selected based on the user input received in step 203. In another embodiment, the web site system 120 may be configured to access additional data regarding the business (i.e. information based on the address of the location) and to generate questions based on this additional data. In general, the questions may be selected to assist in the determination of the expected loss frequency and severity. Loss frequency may be described as the frequency of claims against an employer. Loss severity may be described by, e.g., duration of a disability resulting from an injury, cost associated with the furnishing of lost wages, payment of medical expenses, litigation expenses, a combination of the preceding elements or total dollars, or some similar metric.

In one embodiment, the web site system 120 may be configured to limit the supplemental questions that will be sent to the user. For example, the web site system 120 may be configured to include no more than four or five supplemental questions. In this embodiment, the web site system 120 may be configured to select the best four or five questions from the subset of supplemental questions that will increase the accuracy of the loss frequency and severity calculation. Additionally or alternatively, the supplemental questions may be based on a standard industry code (SIC) associated with the business. Questions may be directed back to the customer, or to other systems that compute risk evaluations using external data sources (e.g. OSHA or Experian).

The web site system 120 then transmits these selected supplemental questions to the user at step 205. The supplemental questions are dynamically selected and may be based on responses to the standard questions, or based on the industry in which the business operates. For example, if the business is related to construction, the supplemental questions may solicit responses to questions concerning the percentage of union membership, the benefits offered, and the existence of drug and alcohol programs. Additionally, the questions may include other supplemental questions based on research concerning factors that affect workers' compensation claims. These questions may be updated based on subsequent research to include additional factors.

The web site system 120 may further be configured to access rate or application information from unrelated types of insurance. For example, the web site system 120 may access the policy management system 104 and determine the business' healthcare premium. The web site system 120 may also compare the business' healthcare premium relative to the average cost in the industry. This value may further assist the risk analysis module 125 in determining the appropriate risk score, wherein the risk score may be a combination of scores for multiple factors. Other census-type information associated with unrelated insurance may also be used, for example, in an educational institution, the degrees held by the staff may be predictive. In healthcare, the licensing of the nursing staff may be relevant. In most industries with hourly work, the amount of overtime is relevant. In manufacturing, the amount of gross sales may be relevant, as might be the amount of square feet in the manufacturing facility etc. In another example, for many industries, the typical 401k investments of the employees may be predictive.

The web site system 120 may further be configured to access motor vehicle records and link them to occupations that have driving exposure. In another example, the web site system 120 may access auto insurance data such as fleet vehicle/personal vehicle ages.

The web site system 120 may also be configured to incorporate premium amounts from other lines of insurance as predictive elements. For example, in rating a workers' compensation risk with significant driving exposures, the amount of auto insurance premium charged compared to a standard rate may be predictive. If an account pays significantly higher than average premiums for its automobile insurance, there is likely a higher than average risk associated with its driving exposures for workers compensation. Likewise, healthcare, life insurance and disability premiums may be treated in a similar fashion.

While the above example describes enhancing workers' compensation risk insurance with information from other types of insurance, the described system is flexible, and may be used for example, to enhance risk analysis for auto insurance by accessing health insurance data (as provided by privacy laws and state and federal regulations).

The web site system 120 may then receive input data responsive to the supplemental questions in step 206.

The web site system 120 may also receive census data concerning the business in step 207. In one embodiment, the census data may be received from the user. In another embodiment, the web site system 120 may be configured to interact with other insurance entities, for example a group benefits insurance system, and receive the census information from the other insurance entity. Of course, this may be performed with the consent of the insured or as regulations permit. Additionally, the web site system 120 may receive data from credit reporting services, or through government records or payroll services (e.g. Paychex).

The web site system 120 implements a software-based algorithm to generate a risk analysis based on the application questions, the supplemental questions, and the census information in step 208.

The web site system 120 then determines, based on the risk, a company with the appetite for the risk and the associated rate.

The web site system 120 may then transmit the list of companies that may offer coverage for the business along with the associated rate for each company.

FIG. 2B shows a flow diagram for a method of supplemental pricing adjustment. As shown in FIG. 2B, agent submits responses to a standard application along with responses to supplemental questions to the web site system 120 and requests a quote at step 211. The web site system 120 processes the standard application form at step 212. The web site system 120 then determines whether the agent provided responses to supplemental questions at step 213. If the agent did not provide responses to supplemental questions, the web site system 120 provides the agent with a first type of quote.

If the agent provided the web site system 120 with responses to supplemental questions, this information is processed via a software-based algorithm. The web site system 120 then determines whether the account qualifies for a pricing adjustment based on the supplemental application. If the account does not qualify, a pricing objective is generated using a software based underwriting algorithm implementing a risk score application at step 217. The risk score application may provide information for pricing evaluations. In one embodiment, the web site system 120 may require input from an underwriter to confirm pricing.

If the account does qualify for supplemental pricing adjustments then the risk score is modified according using a software based algorithm, as well as other adjustments based on the supplemental information at step 217. Finally, based on the risk score in either step 216 or 218, an adjusted quote is produced at step 218.

FIGS. 3-7 show example web pages that may be displayed by the web browser module 112. As will be described in detail below, the web pages may include display elements which prompt the user of the client device 110 for information about the user's business in order to perform a workers' compensation risk assessment. The web pages may be included in a web browser window 200 that is displayed and managed by the web browser module 112. The web pages may include data received by the web browser module 112 from the web site system 120. The web pages may include information related to products sold by the insurance company, information related to clients that have purchased products sold by the insurance company, and other related information.

Referring to FIG. 3, the web browser window 200 may include a control area 265 that includes a back button 260, forward button 262, address field 264, home button 266, and refresh button 268. The control area 265 may also include one or more additional control elements (not depicted). The user of the client device 110 may select the control elements 260, 262, 264, 266, 268 in the control area 265. The selection may be performed, for example, by the user clicking a mouse or providing input via keyboard, touch screen, and/or other type of input device. When one of the elements 260, 262, 264, 266, 268 is selected, the web browser module 112 may perform an action that corresponds to the selected element. For example, when the refresh button 268 is selected, the web browser module 112 may refresh the page currently viewed in the web browser window 200.

As shown in FIG. 3, the web page 302 may include an application question area 330, a cancel button 332, a previous button 334, and a next button 336. The application question area 330 may include a list of standard questions related to workers' compensation application. As shown in FIG. 3 each of the questions has an input field associated with it. The user can select the input field associated with the question and provide text based responses to the questions. Alternatively, some questions may be represented in a drop down list (not shown) or with radio buttons (also not shown). The list of questions shown in FIG. 3 is not exhaustive and is shown as an example. The standard questions provided in the application question area 330 may be provided to all users seeking workers' compensation insurance.

As the user provides input into the input fields in the application question area 330, the web browser module 112 may store one or more data structures (“response data”) that reflect the data entered into in the input fields. Further, as the data is entered, the web browser module 112 may update the application question area 330 to indicate additional or more specific questions or to remove non-relevant questions. As an example, a user might enter, via a user device, a response to question 7 “Have you ever been declined coverage for workers' compensation” in the affirmative. In this scenario, the web browser module 112 may respond to the user input and update the web page 302 to include addition questions soliciting information about the date and reason for the declined coverage. For questions requiring a binary response (e.g. Yes or No), the web browser module 112, may provide the user with a radio button by which to enter input data.

At any time, while viewing the webpage 302 of FIG. 3, the user may select the cancel button 332, which cancels any pending action and returns the user to a homepage (not shown). Selecting the previous button 334 allows the user to return to the previous screen, while remaining in a session. Selecting the next button 336 enters the selections which are then transmitted to the web site system 120. If there are no errors in the transmission, the web browser module 112 is directed to a subsequent web page.

FIG. 4 shows a web page 402 after the user has entered information to webpage 302 and submitted the information via the next button 336. FIG. 4 shows an example of a supplemental questions webpage, which may include a supplemental question area 430, a cancel button 432, a previous button 434, and a next button 436. As shown in FIG. 4, the web site system 120 has determined supplemental questions, which are selected in response to the information provided to the web site system 120 in response to the questions provided to webpage 302. Each type of business may have different factors associated with it that affect the loss frequency and severity. Additionally, the questions may have different impacts on pricing direction based upon a comparison of data for a typical response for a similar business (similar by size, specialty, geography, years in business, etc.) The web site system 120 implements a software-based algorithm to select questions from the subset of supplemental questions. The algorithm is updatable based on research indicating which factors affect the risk associated with coverage. These supplemental questions provided may be selected using a multivariate analysis. Based on the responses to each question and other data available about the business, as well as responses to supplemental questions, the web site system 120 may update and refresh the supplemental questions. The selected supplemental questions are transmitted to the web browser module 112 to solicit information to more accurately determine risk associated with coverage.

As the user provides input into the input fields in the application question area 430, the web browser module 112 may store one or more data structures (“response data”) that reflect the data entered into in the input fields. Further, as the data is entered, the web browser module 112 may update the supplemental question area 430 to indicate additional or more specific questions or to remove non-relevant questions. For questions requiring a binary response (e.g. Yes or No), the web browser module 112, may provide the user with a radio button by which to enter input data.

At any time, while viewing the webpage 402 of FIG. 4, the user may select the cancel button 432, which cancels any pending action and returns the user to a homepage (not shown). Selecting the previous button 434 allows the user to return to the previous screen (e.g. web page 302), while remaining in a session. Selecting the next button 436 enters the selections which are then transmitted to the web site system 120. If there are no errors in the transmission, the web browser module 112 is directed to a subsequent web page.

Referring now to FIG. 5, FIG. 5 shows a web page 502 after the user has entered information on webpage 402 and submitted the information via the next button 436. FIG. 5 shows a web page 502 for determining additional available sources of information, such as sources of employee census data, which may include employee census area 530, a cancel button 532, a previous button 534, and a next button 536. Census data may be a useful data point in determining the risk associated with providing workers' compensation coverage. This data may also be useful and relevant in determining other types of insurance. Accordingly, the results module 124 may transmit this information to the policy management system 104, which may update the pricing for other insurance products, such as disability, etc. The additional information, such as census data, may be collected from various entities. As shown in FIG. 5, web browser module 112 may present the user with multiple options for providing census data to web site system 120. Census area 530 includes questions that solicit responses related to sources for census data. As shown in FIG. 5, web browser module 112 provides radio buttons 531 and 533 next to questions requiring a binary input. Web browser module 112 also includes a drop-down menu 532 in census area 530 to solicit a response from the user of the user device.

As the user provides input into the input fields in the census area 530, the web browser module 112 may store one or more data structures (“response data”) that reflect the data entered into in the input fields. Further, as the data is entered, the web browser module 112 may update the census area 530 to indicate additional or more specific questions or to remove non-relevant questions. For example, if the user selects “yes” in response to a question presented in input field 530, web browser module 112 may update webpage 502 to include a drop down menu. The user of the user device may select one or more options from the drop down menu indicating the source of the census information. By selecting an option in the drop down menu, the web site system 120 is authorized to communicate with an outside server to collect census information. Alternatively, if the user selects the “manually enter” option from the drop down menu, user may be presented with a new web page with additional questions. In another option, the user may select a radio button to collect census information from the insurance company. In some instances, the business will have already obtained another type of coverage from the insurance company. By selecting this option, the web site system 120 is authorized to retrieve census information associated with the business that may have been collected for a separate insurance product (e.g. group benefits).

The web site system 120 may also collect this information and information across many clients to create demographic profiles for businesses that are supported by multivariate elements. Of course, this may be performed with the consent of the insured or as regulations permit.

At any time, while viewing the webpage 502 of FIG. 5, the user may select the cancel button 532, which cancels any pending action and returns the user to a homepage (not shown). Selecting the previous button 534 allows the user to return to the previous screen (e.g. web page 402), while remaining in a session. Selecting the next button 536 enters the selections which are then transmitted to the web site system 120. If there are no errors in the transmission, the web browser module 112 is directed to a subsequent web page.

Referring now to FIG. 6, FIG. 6 shows a web page 602 after the user has selected entered information on webpage 502 and submitted the selection via the next button 536. FIG. 6 shows a web page 602 for manually entering census information, which may include employee census input area 630, a cancel button 632, a previous button 634, and a next button 636. Web page 602 includes census input area 630 which provides the user a table to enter information for each employee. The input area 630 may include questions concerning, e.g. the name of the employee, the number of hours worked in a week, the employee's date of birth, the employees gender, data concerning the employees immediate family, salary information, employer offered benefit selections, and the address of the employee. These census questions are provided as an example, but are by no means exhaustive. Other examples of census type information may include, but is not limited to BMI, prior medical history, prior workers' compensation claims history, Lipid Panels, MVR, whether the individual rents or owns their home. All of the census data may be masked or aggregated to protect individual's privacy pursuant to state, federal, and employer regulations.

As the user provides input into the input fields in the census input area 630, the web browser module 112 may store one or more data structures (“response data”) that reflect the data entered into in the input fields. Further, as the data is entered, the web browser module 112 may update the census input area 630 to indicate additional or more specific questions or to remove non-relevant questions.

At any time, while viewing the webpage 602 of FIG. 6, the user may select the cancel button 632, which cancels any pending action and returns the user to a homepage (not shown). Selecting the previous button 634 allows the user to return to the previous screen (e.g. web page 502), while remaining in a session. Selecting the next button 636 enters the selections which are then transmitted to the web site system 120. If there are no errors in the transmission, the web browser module 112 is directed to a subsequent web page.

After the web site system 120 has collected the information from the user, the web site system 120 implements a software-based algorithm to generate risk information as well as pricing and premium information. This may include access the quoting/binding module 122, the results module 124, the risk analysis module 125 and the policy management system 104.

In one embodiment, the risk analysis module 125 may receive the information provided by the web site system 120. The risk analysis module 125 may generate baseline risks for each industry based on the salary of employees in a certain class. This baseline risk may be determined, for example, based on the response to the first set of questions. The risk analysis module 125 may adjust the results based on, for example, the business' credibility rating, exposure rating, and loss rating. The adjustment may be based on the supplemental questions, census data or other data received about the company or industry. For example, the credibility rating may be based on the business size, years of operation, and/or a comparison of answers provided by the user with information available from other sources (e.g. OSHA, different insurance products etc.) The exposure rating may be based on the amount of employees and the type of claims filed by those employees. The loss rating may be based on the number of claims filed by the company as compared to the industry norms. The policy management system 104 may provide information to the risk analysis module 125 concerning an experience modifier, which may adjust the loss rating on the past history making claims. The software-based algorithm implemented in web site system 120 may be configured to account for the experience modifier to assure that a particular factor is not oversampled in determining risk.

The results module 124 and risk analysis module 125 may be configured to use a multivariate analysis to determine the risk and an appropriate company to provide coverage. A predictive model, as described in U.S. Pat. No. 7,945,497 (System and method for utilizing interrelated computerized predictive models), which is incorporated by reference in its entirety, may be used.

Referring now to FIG. 7, an example results web page 702 is shown after the user has entered information to a previous webpage and submitted the information via the next button. The example results web page 702 includes information generated by the results module 124 and the risk analysis module 125, and which may be displayed by the web browser module 112. According to the example of FIG. 7, the results module 124 determines the contents of the example results web page 702 based on the user information transmitted in response to the web pages shown in FIGS. 3-6. The information that describes the contents of the example results web page 702 was received by the web browser module 112. The results web page 702 includes multiple output fields 731, 732, and 733. Output field 731, for example may include information such as a standard premium, information concerning any credits or debits provided, and an overall net premium. Output field 732 may include information such as a loss rating, risk/renewal score, exposure rating, and system generated expected losses. Output field 733 may include information such as the expected amount of commission in total dollars, the expected amount of losses in total dollars and the net expected gains. Output field 733 may also provide indicated & selected pricing, which provides a net premium for monoline customers and multiline customers. The results module 124 may produce multiple sets of results based on the size of the company (i.e. the size of the risk).

Additionally, webpage module 112 may provide the user with input area 730 which allow the user to enter severity potential ratings as well as expected commission. When the user enters information into input area 730 the web browser module 112 may generate one or more data structures that reflect the values indicated. The user may request for a recalculation of the premium/pricing information by selecting button 932. The web browser module 112 may then transmit the data to the web site system 120. The results module 124 may then receive the data, and process the data in the same way that the results module 124 processes question response data, as described above. The web site system 120 may then transmit a new results page to the web browser module 112. The new results page may have a similar or identical format to the results web page 702 shown in FIG. 7 adding updated premium/pricing information. The web browser module 112 may display the new results page in the web browser window 200.

The user may request a binding quote using button 734. After receiving the binding quote, the user may submit a bid accepting the costs. If the user submits a bid accepting the costs, the web browser module 112 may interact with the quoting/binding module 122 and/or the policy management system 104, and enter into a binding agreement to purchase an insurance product from the insurance company. Information related to the user's business may be communicated to the quoting/binding module 122 and/or the policy management system 104, to facilitate obtaining the quote or the purchase of the insurance product. Alternatively or additionally, in response to a user input in one of the previous web pages, the web browser module 112 may navigate to a web page that has contact information (such as a phone number and/or email address) for an employee or agent of the insurance company. The user may then contact the employee/agent via phone and/or email, and initiate the purchase of a product from the insurance company. Alternative or additionally, in response to a user input, the web browser module 112 may navigate to another web page within the web site of the insurance company.

The web site system 120 may further be configured to transmit information to an agent or insurer to provide the insurance company internal direction as well as pricing to the user. For example, the web site system 120 may select supplemental questions that provide guidance for the available limits of insurance. The web site system 120 may determine dividend or deductible programs of interest to the insured based on the response to the supplemental questions.

The web site system 120 may be configured to determine whether reinsurance is required based on the individual risk characteristics and notify the insurance company of the requirement. For example, the results module 124 may be configured to trigger a reinsurance requirement on a condition the risk analysis module 125 outputs a predetermined risk rating. The web site system 120 may be configured to automatically notify a reinsurance agent, via email, text message or other electronic communication medium.

The web site system 120 may also be configured to generate loss control information based on the received responses to the supplemental questions and the external data. For example, based on a the results of the risk analysis module 125, the web site system 120 may require a confirmed site inspection before allowing a user to provide a binding quote or to require a set deductible.

The web site system 120 may also be configured to generate a referral to multiple levels of underwriting staff. For example, a highly complicated risk may be referred to an underwriter while a less complicated risk may be processed directly by an agent with no manual carrier underwriting intervention. Additionally, for those more complicated risks, some with moderate amounts of complexity may be triaged to less experienced staff, while risks requiring more experienced underwriting judgment would be referred to senior staff, or a carrier's home office review team.

FIG. 8 shows an example computing device 810 that may be used to implement features described above with reference to FIGS. 1-7. The computing device 810 may include a processor 818, memory device 820, communication interface 822, input device interface 812, display device interface 814, and storage device 816. FIG. 8 also shows a display device 824, which may be coupled to or included within the computing device 810.

The memory device 820 may be or include a device such as a Dynamic Random Access Memory (D-RAM), Static RAM (S-RAM), or other RAM or a flash memory. The storage device 716 may be or include a hard disk, a magneto-optical medium, an optical medium such as a CD-ROM, a digital versatile disk (DVDs), or Blu-Ray disc (BD), or other type of device for electronic data storage.

The communication interface 822 may be, for example, a communications port, a wired transceiver, a wireless transceiver, and/or a network card. The communication interface 822 may be capable of communicating using technologies such as Ethernet, fiber optics, microwave, xDSL (Digital Subscriber Line), Wireless Local Area Network (WLAN) technology, wireless cellular technology, and/or any other appropriate technology.

The input device interface 812 may be an interface configured to receive input from an input device such as a keyboard, a mouse, a trackball, a touch screen, a touch pad, a stylus pad, and/or other device. The input device interface 812 may operate using a technology such as Universal Serial Bus (USB), PS/2, Bluetooth, infrared, and/or other appropriate technology.

The display device interface 814 may be an interface configured to communicate data to display device 824. The display device 824 may be, for example, a monitor or television display, a plasma display, a liquid crystal display (LCD), and/or a display based on a technology such as front or rear projection, light emitting diodes (LEDs), organic light-emitting diodes (OLEDs), or Digital Light Processing (DLP). The display device interface 814 may operate using technology such as Video Graphics Array (VGA), Super VGA (S-VGA), Digital Visual Interface (DVI), High-Definition Multimedia Interface (HDMI), or other appropriate technology. The display device interface 814 may communicate display data from the processor 818 to the display device 824 for display by the display device 824. As shown in FIG. 8, the display device 824 may be external to the computing device 810, and coupled to the computing device 810 via the display device interface 814. Alternatively, the display device 824 may be included in the computing device 800.

An instance of the computing device 810 of FIG. 8 may be configured to perform any feature or any combination of features described above as performed by the client device 110. In such an instance, the memory device 820 and/or the storage device 816 may store instructions which, when executed by the processor 818, cause the processor 818 to perform any feature or any combination of features described above as performed by the web browser module 112. In such an instance, the computing device 810 may be, for example, a laptop computer, a tablet computer, a desktop computer, cellular phone (such as but not limited to the cellular phone 900 described below with reference to FIG. 9), a personal digital assistant (PDA), or any other appropriate computing device.

Alternatively or additionally, an instance of the computing device 810 may be configured to perform any feature or any combination of features described above as performed by the quoting/binding module 122, HTTP service module 124, CMS 126, and/or results module 124. In such an instance, the memory device 820 and/or the storage device 816 may store instructions which, when executed by the processor 818, cause the processor 818 to perform any feature or any combination of features described above as performed by the quoting/binding module 122, HTTP server module 123, CMS 126, results module 124, and/or the risk analysis module 125. In such an instance, the computing device 810 may be a server computer or any other appropriate computing device.

Further, an instance of the computing device 810 may be configured to perform any features or combination of features described above as performed by the policy management system 104. In such an instance, the memory device 820 and/or the storage device 816 may store instructions which, when executed by the processor 818, cause the processor 818 to perform any feature or any combination of features described above as performed by the policy management system 104. In such an instance, the computing device 810 may be a server computer or any other appropriate computing device.

FIG. 9 shows a cellular phone 900 that is a more specific example of the computing device 800 described above with reference to FIG. 8. The cellular phone may include a touch screen 924, and may also include a processor (not depicted), memory device (not depicted), communication interface (not depicted), input device interface (not depicted), display device interface (not depicted), and storage device (not depicted), which may possess characteristics of processor 818, memory device 820, communication interface 822, input device interface 812, display device interface 814, and storage device 816 described above with reference to FIG. 8. The touch screen 924 is a more specific example of the display device 824 described above with reference to FIG. 8, and may be based on technology such as, for example, LCD, LED, and/or other appropriate display technology. The touch screen 924 may receive user input using technology such as, for example, resistive sensing technology, capacitive sensing technology, optical sensing technology, or any other appropriate touch-sensing technology. The touch screen 924 may provide user input data to the input device interface (not depicted) in the cellular phone 900. The communication interface (not depicted) in the cellular phone may be a wireless transceiver, and may be capable of communicating using wireless technology such as Long Term Evolution (LTE), LTE-Advanced (LTE-A), Universal Mobile Telecommunications System (UMTS), IEEE Institute of Electrical and Electronics Engineers (IEEE) 802.16/WiMax, IEEE 802.16m, Wireless Broadband (WiBro), Global System for Mobile Communications (GSM), Enhanced Data Rates for GSM Evolution (EDGE) Radio Access Network (GERAN), Code Division Multiple Access 2000 (CDMA2000), and/or any other appropriate wireless technology.

The touch screen 924, as shown in FIG. 9, may display input and output areas similar to the features of the web pages described in FIGS. 3-7 above. As described above with reference to FIG. 8, the processor in the cellular phone 800 may execute instructions which cause the processor to perform the functionality described above as performed by the web browser module 112. This may include displaying the display elements in the touch screen 924, as shown in FIG. 9. These display elements may display similar data and receive user input in a similar fashion as that described above with respect to the corresponding display elements of FIGS. 3-7. A user of the cell phone 900 may interface with these display elements by using the touch screen 924.

Although examples are provided above with reference to FIGS. 1-9 wherein data is communicated between a web site system 120 and a web browser module 122, the features described above as performed by the web site system 120 and/or the web browser module 122 may be implemented in any combination of software and/or hardware. For example, the features described above as performed by the web browser module 122 and/or the web site system 120 may be performed, mutatis mutandis, by one or more dedicated or special-purpose applications.

Although the examples provided above with reference to FIGS. 1-9 are described as being performed by a client device 110, the same methods may be performed by agent device 111.

Although examples are provided above with respect to workers' compensation insurance related to businesses, business owners, and business insurance product, the features describe above with reference to FIGS. 1-9 are equally applicable, mutatis mutandis, to other contexts including but not limited to automobile, general liability, and property as well as for claims applications such as to triage complex accounts to more experienced staff and identify risk characteristics as acceptable and/or unacceptable for a specific threshold or appetite. For example, the features described above may be used for the communication of information related to and/or the selection of insurance products that are applicable to all types of insurance consumers, including individuals, businesses, non-profit entities, governmental entities, and/or any other types of insurance consumers. For example, the features described above may be used for communication of information related to and/or the selection of individual insurance products, and/or any other insurance products. Alternatively or additionally, the features described above may be used for the communication of information related to and/or the selection of financial products that are not insurance products, such as risk management services, bonds, retirement plans, savings plans, and/or group benefits plans.

When referred to herein, the term “computer-readable medium” broadly refers to and is not limited to a register, a cache memory, a ROM, a semiconductor memory device (such as a D-RAM, S-RAM, or other RAM), a magnetic medium such as a flash memory, a hard disk, a magneto-optical medium, an optical medium such as a CD-ROM, a DVDs, or BD, or other device for electronic data storage.

As used herein, the term “processor” broadly refers to and is not limited to a single- or multi-core general purpose processor, a special purpose processor, a conventional processor, a digital signal processor (DSP), a plurality of microprocessors, one or more microprocessors in association with a DSP core, a controller, a microcontroller, one or more Application Specific Integrated Circuits (ASICs), one or more Field Programmable Gate Array (FPGA) circuits, any other type of integrated circuit (IC), a system-on-a-chip (SOC), and/or a state machine.

Although features and elements are described above in particular combinations, each feature or element can be used alone or in any combination with the other features and elements. For example, each feature or element described above with reference to any one or any combination of FIGS. 1-9 may be used alone without the other features and elements or in various combinations with or without other features and elements described above with reference to any one or any combination of FIGS. 1-9. Sub-elements of the methods and features described above may be performed in any arbitrary order (including concurrently), in any combination or sub-combination.

What is claimed is:

1. A system for the generating automated underwriting information related to workers' compensation insurance for a business, the system comprising:
a memory device configured to store a set of standard workers' compensation questions and a set of supplemental questions;
a transmitter configured to transmit the set of standard workers' compensation questions to a user device;
a receiver configured to receive a response to the set of standard workers' compensation questions from the user device and to store the response to the set of standard workers' compensation questions in the memory device;
the processor configured to select a subset of the set of supplemental questions based on the received responses to the set of standard workers' compensation questions;
the transmitter further configured to transmit the subset of supplemental questions to the user device;
the receiver further configured to receive a response to the subset of supplemental questions and to store these responses in the memory device;
the processor further configured to generate a risk score for workers' compensation insurance based on at least the responses to the standard workers' compensation questions and the responses to the supplemental questions;
the processor further configured to determine an insurance company with an appetite to insure the business based on the determined risk score; and
a transmitter configured to transmit the information concerning the determined insurance company to the user device.

2. The system of claim 1 further configured to negotiate a quote with the selected insurance company to provide quote information based on the risk score.

3. The system of claim 1, wherein the processor is configured to access census information about the business associated with associated with a different insurance product.

4. The system of claim 2, wherein the risk score is further based on the census information.

5. The system of claim 1, wherein at least one supplemental question is determined based on a response to another supplemental question.

6. The system of claim 1, wherein the receiver is further configured to receive Occupational Safety and Health Administration (OSHA) information from an OSHA database.

7. The system of claim 2, wherein the risk score is further based on the received OSHA information.

8. The system of claim 1, wherein the processor determines that no insurance company has an appetite to insure a business with the determined risk.

9. A method for the generating automated underwriting information related to workers' compensation insurance for a business, the method comprising:
storing, by a memory device, a set of standard workers' compensation questions and a set of supplemental questions;
transmitting, by a transceiver, the set of standard workers' compensation questions to a user device;
receiving, by the transceiver, a response to the set of standard workers' compensation questions from the user device and storing the response to the set of standard workers' compensation questions in the memory device;
selecting, by a processor, a subset of the set of supplemental questions based on the received responses to the set of standard workers' compensation questions;
transmitting, by the transceiver, the subset of supplemental questions to the user device;
receiving, by the transceiver, a response to the subset of supplemental questions and to storing these responses in the memory device;
generating, by the processor, a risk score for workers' compensation insurance based on at least the responses to the standard workers' compensation questions and the responses to the supplemental questions;
determining, by the processor, an insurance company with an appetite to insure the business based on the determined risk score; and
transmitting, by the transceiver, the information concerning the determined insurance company to the user device.

10. The method of claim 9, further comprising negotiating a quote with the selected insurance company to provide quote information based on the risk score.

11. The method of claim 9, further comprising accessing census information about the business associated with associated with a different insurance product.

12. The method of claim 11, wherein the risk score is further based on the census information.

13. The method of claim 9, wherein at least one supplemental question is determined based on a response to another supplemental question.

14. The method of claim 9, further comprising receiving Occupational Safety and Health Administration (OSHA) information from an OSHA database.

15. The method of claim 14, wherein the risk score is further based on the received OSHA information.

16. The method of claim 9, further comprising determining that no insurance company has an appetite to insure a business with the determined risk.

17. A system for the generating automated underwriting information related to insurance for a business, the system comprising:
a memory device configured to store a set of standard questions related to a first type of insurance and a set of supplemental questions;
a transmitter configured to transmit the set of standard questions to a user device;
a receiver configured to receive a response to the set of standard questions from the user device and to store the response to the standard workers' compensation questions in the memory device;
the processor further configured to access census information associated with a second type of insurance related to the business;
the processor configured to select a subset of the set of supplemental questions based on the received responses to the set of standard workers' compensation questions;
the transmitter further configured to transmit the subset of supplemental questions to the user device;
the receiver further configured to receive a response to the subset of supplemental questions and to store these responses in the memory device;
the processor further configured to generate a risk score for workers' compensation insurance based on at least the responses to the standard workers' compensation questions, the responses to the supplemental questions, and the census information associated with the second type of insurance;
the processor further configured to determine an insurance company with an appetite to insure a business based on the determined risk score; and
a transmitter configured to transmit the information concerning the determined insurance company to the user device.
